(19) United States
(12) Patent Application Publication
(10) Pub. No.: US 2011/0258823 A1
(43) Pub. Date: Oct. 27, 2011

(54) WHEEL CHECK TOOL

(76) Inventors: DARRELL KRUIZE, Snoqualmie, WA (US); KEN KRUIZE, Snoqualmie, WA (US)

(21) Appl. No.: 12/764,948

(22) Filed: Apr. 22, 2010

(51) Int. Cl. B25B 27/14

(52) U.S. Cl. 29/278

(57) ABSTRACT

The present invention relates to a wheel check installation tool for the installation and removal of wheel checks onto lug nuts comprising: a handle section; a mounting section, where said mounting section includes a nut receptacle and adjoins to the handle section; a mechanism to adjoin the handle section and the mounting section; and a spring, where said spring inserts into an opening of the mounting section along with the handle section, where the handle section is pushed inwardly toward the mounting section to abut a wheel check onto a lug nut. The nut receptacle surrounds the lug nut as the wheel check is pushed onto the nut. The mechanism to adjoin may include a screw, where screw inserts into an opening within the nut receptacle. The spring lies within the inner wall of the mounting section and abuts the enclosed end of the handle section.

### BACKGROUND OF THE INVENTION

1. Field of Invention

The present invention relates to a tool utilized to insert wheel check indicators onto the lug nuts of tractor-trailers.

2. Description of Related Art

The trucking transportation industry involves transportation and distribution of goods throughout the country typically through the use of a tractor-trailer also known as 18-wheeler vehicles. These trucks transport large quantities of materials, goods, equipment and occasionally smaller vehicles to various locations. Furthermore tractor-trailers also transport construction materials including rocks, dirt, concrete and other building materials. Many times these vehicles are placed on a road for up to 11 hours a day and are driven across the highways and roadways throughout the country.

Because of the size of the vehicles and hours of operation, safety is paramount in operating these vehicles. One area of particular area of concern with respect to these vehicles includes the wheels and tires that are used on the trucks. The wheels are mounted onto hubs and utilize a lug nut fastening system to mount the wheels. It is imperative that the wheels remain in tact while transporting these large vehicles and materials over the roadways. A common device used to assist in maintaining secure wheels are wheel checks. A wheel check is a loose wheel nut indicator that is used to identify loose lug nuts with a visual inspection. Lug nuts are torqued to specific foot-pound ratings in order to secure the wheel to the hub. The wheel check is placed over each lug nut by pushing the check into place using an individual's thumbs. Once the wheel check is placed over the lug nut this process is repeated for the remaining lug nuts along the perimeter of the wheel. Once all the wheel checks are placed over the lug nuts they form a uniform pattern and therefore if a lug nut becomes loosened the aberration of the pattern is easily visible on a visual inspection of the wheel. Placement of the wheel checks therefore can alert the driver of any loose lug nuts and helps prevent any accidents that may occur due to loose lug nuts. Many times the lug nuts may loosen simply due to operation over a period of time and vibration associated with travel.

The placement of the wheel check onto lug nuts can be a time consuming activity due to the number of lug nuts that may be on a tractor-trailer. Many times the wheels of a tractor-trailer may have up to ten lug nuts therefore requiring a wheel check on each lug nut. Also up to ten wheels or more may be on a tractor-trailer requiring a set of a wheel checks to be placed on the lug nuts. Therefore, it would be advantageous to have a tool that could assist in the insertion and application of wheel checks onto a lug nut. Such a tool could alleviate some physical effort necessary when manually placing the wheel checks onto the lug nuts.

### SUMMARY OF THE INVENTION

The present invention relates to a wheel check installation tool for the installation and removal of wheel checks onto lug nuts comprising: a handle section; a mounting section, where said mounting section includes a nut receptacle and adjoins to the handle section; a means to adjoin the handle section and the mounting section; and a spring, where said spring inserts into an opening of the mounting section along with the handle section, where the handle section is pushed inwardly toward the mounting section to abut a wheel check onto a lug nut. The nut receptacle surrounds the lug nut as the wheel check is pushed onto the nut. The means to adjoin may include a screw, where screw inserts into an opening within the nut receptacle. The spring lies within the inner wall of the mounting section and abuts the enclosed end of the handle section.

### BRIEF DESCRIPTION OF DRAWINGS

FIG. 1 depicts a wheel check installer according to the present invention.

### DETAILED DESCRIPTION

The present invention relates to a wheel check installation tool that may be used by a maintenance person, truck driver or mechanic to install a wheel check over the lug nut of a tractor-trailer or truck wheel. The installation of wheel checks provides a visual aid in determining whether a lug nut has become loose over a period of time. The use of the wheel check installation tool according to the present invention eliminates the manual effort that is necessary to push the wheel check onto the lug nut during installation. The use of a wheel check installation tool provides a quicker and easier method to install wheel checks onto the lug nuts.

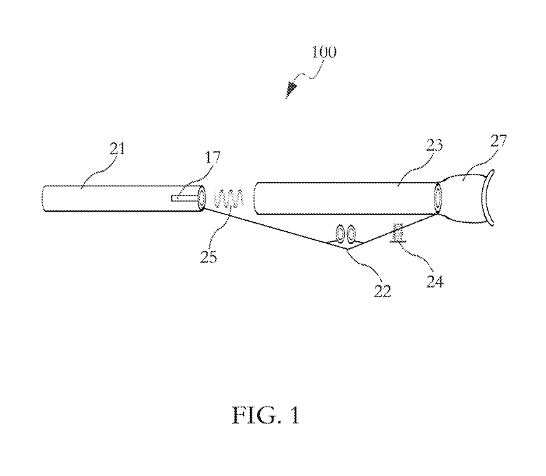

FIG. 1 depicts a wheel check installation tool 100 according to the present invention. The installation tool 100 comprises two pieces that are used together to create a single tool for the installation and removal of wheel checks onto lug nuts. The installation tool 100 includes a handle section 21 that joins with the mounting section 23. A spring 25 inserts into the mounting section 23 along with the handle section 21 of the installation tool 100. Once the two sections 21 and 23 are joined, the tool may be use to insert a wheel check onto a lug nut. The mounting section 23 includes a nut receptacle 27. The wheel check is placed at the open end of the nut receptacle 27 and then the handle section 21 is pushed inwardly toward the mounting section 23 to abut the wheel check onto the lug nut.

As the wheel check is placed upon a lug nut, the nut receptacle 27 received surrounds the lug nut as the wheel check is pushed onto the nut. A screw 24 inserts into an opening at the nut receptacle 27 in the mounting section 23. The screw 24 adjoins the handle section 21 to the mounting section 23 where the spring lies between the inner wall of the mounting section 23 and the end of the handle section 21. An attachment slot 17 is provided on one side of the handle section 21 to align the handle section 21 with the mounting section 23 once the two sections are adjoined for use. A washer 22 is also provided on the inside of the installation tool 100 and above the opening inside the nut receptacle 27. Once the installation tool is assembled the tool may be used to easily insert and mount wheel checks on lug nuts as needed. The wheel check tool 100 may also be used to remove wheel checks from the lug nuts by reversing the direction of the check installation tool 100. The user may use the opposite end of the wheel check installation tool 100 to remove the wheel check from the lug nut.

The wheel check installation tool provides an easy and quick method to install wheel checks indicators on lug nuts. In one particular embodiment of the present invention, the wheel check installation tool may be up to 10 inches in length and made of lightweight, durable materials. Use of the wheel check installation tool eliminates stress and aggravation associated with the manual placement of wheel checks onto lug nuts. The instant invention has been shown and described in what it considers to be the most practical and preferred embodiments. It is recognized, however, that departures may be made there from within the scope of the invention and that obvious modifications will occur to a person skilled in the art.

What is claimed is:

1. A wheel check installation tool for the installation and removal of wheel checks onto lug nuts comprising:
a. a handle section;
b. a mounting section, where said mounting section includes a nut receptacle and adjoins to the handle section;
c. a means to adjoin the handle section and the mounting section; and
d. a spring, where said spring inserts into an opening of the mounting section along with the handle section, where the handle section is pushed inwardly toward the mounting section to abut a wheel check onto a lug nut.

2. The wheel check installation tool according to claim 1, where the nut receptacle surrounds the lug nut as the wheel check is pushed onto the nut.

3. The wheel check installation tool according to claim 1, where said means to adjoin includes a screw, where said screw inserts into an opening within the nut receptacle.

4. The wheel check installation tool according to claim 1, where the spring lies within the inner wall of the mounting section and abuts the enclosed end of the handle section.

5. The wheel check installation tool according to claim 1, further including an attachment slot on one side of the handle section, said slot aligns the handle section within the mounting section, once the handle section and mounting section have been adjoined.

6. The wheel check installation tool according to claim 1, further including a washer on the inside of the mounting section and within the opening within the nut receptacle.
